(19) United States
(12) Patent Application Publication
(10) Pub. No.: US 2009/0119506 A1
(43) Pub. Date: May 7, 2009

(54) Method and Apparatus for Secure Assertion of Resource Identifier Aliases

(75) Inventors: Andrew Allen, Mundelein, IL (US); Michal A. Rybak, Upper Mount Standfast (BB)

Correspondence Address: Research in Motion Corp./DLG;Attn: Glenda Wolfe, Building 6, Brazos East, Suite 100, 5000 Riverside Drive, Irving, TX, 75039, US

(73) Assignee: Research In Motion Limited, Waterloo (CA)

(21) Appl. No.: 12/245,607

(22) Filed: Oct. 3, 2008

Related U.S. Application Data
(60) Provisional application No. 60/977,952, filed on Oct. 5, 2007.

(51) Int. Cl. H04L 9/32; H04L 9/08

(52) U.S. Cl. 713/156; 380/283; 380/270

(57) ABSTRACT

A method and apparatus for secure assertion of a user identifier alias. The method comprises receiving at an application server from a first device a first user identifier, a first device identifier and a first authentication key associated with the first device; receiving at the application server from the first device a second user identifier, the first device identifier and a second authentication key associated with the first device; comparing the first authentication key to the second authentication key; and storing the second user identifier at the application server as an alias of the first user identifier if the first authentication key matches the second authentication key.

### CROSS-REFERENCE TO RELATED APPLICATIONS

This application claims priority to U.S. Provisional Patent Application Ser. No. 60/977,952, filed Oct. 5, 2007, which is herein incorporated by reference.

### TECHNICAL FIELD OF THE APPLICATION

The present disclosure generally relates to communication via packet data service networks. More particularly, and not by way of any limitation, the present disclosure is directed to a mobile communications device and related data service network employing a method and system for securely asserting one or more aliases of a resource identifier.

### BRIEF DESCRIPTION OF THE DRAWINGS

A more complete understanding of the embodiments of the present disclosure may be had by reference to the following Detailed Description when taken in conjunction with the accompanying drawings wherein:

FIG. 1 depicts a network environment within which certain of the presently-disclosed methods may be implemented;

FIG. 2 depicts a message flow diagram showing messages communicated between servers and mobile communication devices according to the present disclosure;

FIGS. 3-11B depict graphical representations of certain transactions modifying the data stored and the associations between the data stored at a server;

FIGS. 12-19 depict block diagrams of the status of data structures modifying the data stored and the associations between the data stored at a server;

FIG. 20 depicts a flow chart showing a first process for asserting an alias of a user identity;

FIG. 21A depicts a flow chart showing a second process for asserting an alias of a user identity;

FIG. 21B depicts a flow chart showing a third process for asserting an alias of a user identity; and

FIG. 22 depicts a block diagram of a mobile communication device; and

FIG. 23 depicts a block diagram of a server.

### DETAILED DESCRIPTION OF THE DRAWINGS

A method and apparatus of the present disclosure will now be described with reference to various examples of how the embodiments can best be made and used. Identical reference numerals are used throughout the description and several views of the drawings to indicate identical or corresponding parts, wherein the various elements are not necessarily drawn to scale.

According to a first aspect, the present disclosure relates to a method for secure assertion of a user identifier alias. The method comprises receiving at an application server from a first device a first user identifier, a first device identifier and a first authentication key associated with the first device; receiving at the application server from the first device a second user identifier, the first device identifier and a second authentication key associated with the first device; comparing the first authentication key to the second authentication key; and storing the second user identifier at the application server as an alias of the first user identifier if the first authentication key matches the second authentication key.

In certain embodiments, the first device and the application server communicate via a wireless data path, which may include a wireless packet service data path, a wide area cellular network, or both. The method may further comprise receiving at the application server, from a second device, the second user identifier, a second device identifier and a second authentication key; and storing the second device at the application server as an associated device for the second user identifier. The method may further comprise receiving at the application server from the second device the second user identifier, the second device identifier, the second authentication key and a third user identifier; and storing the third user identifier as an alias for the second user identifier. Finally, the method may further comprise transmitting to the second device a communication directed to the second user identifier.

According to a second aspect, the present disclosure relates to a method for secure assertion of a user identifier alias. The method comprises sending to an application server from a first device a first user identifier, a first device identifier and a first authentication key associated with the first device; sending to the application server from the first device a second user identifier, the first device identifier and the first authentication key; and receiving at the first device a communication directed to the second user identifier as a result of an alias relationship at the application server between the first user identifier and the second user identifier.

According to a third aspect, the present disclosure relates to an application server comprising means for receiving at the application server from a first device a first user identifier, a first device identifier and a first authentication key associated with the first device; means for receiving at the application server from the first device a second user identifier, the first device identifier and a second authentication key associated with the first device; means for comparing the first authentication key to the second authentication key; and means for storing the second user identifier at the application server as an alias of the first user identifier if the first authentication key matches the second authentication key.

More generally, the present disclosure relates to authentication of devices such as phones, PDAs and computers, having associated user identifiers, to a network based application server interacting with corresponding applications on the devices in order to provide certain communication-related services to a user of the devices. To do this, it is preferable that the network based application server have access to information relating to the relationship of the user identities and devices associated with a user and their relevance to particular applications. Generally, such applications will support end-to-end secure communication between the devices and the network based application server for the purposes of configuration of the service, state synchronization, notification of settings and indication of the presence and status of applications on the devices.

Session Initiation Protocol (SIP) and other internet based communication technologies support both multiple user identities (e.g., Public User IDs or URIs) being registered for a single user and multiple devices registered with the same user identity (URI). Employment of multiple user identities enables a user to have different user identities to give to family, friends, and co-workers. Communication filtering and diverting services can be set up based upon the user identity to which a particular communication is addressed. A user may, for example, configure their call forwarding service to allow the address they provided to family members to reach them directly at their mobile phone, while friends are forwarded to their personal voicemail and co-workers are forwarded to their office phone. Association of multiple devices with a single URI relieves the user of the burden of maintaining different user identities for their home phone, personal mobile phone, work phone, corporate mobile devices, vacation home phone, laptop computer Voice over IP (VoIP) client and fax machine. Instead, the user can make him or herself available via whichever device(s) they happen to be using, or proximate to, at a given time. This functionality also reduces the burden of maintaining large lists of device oriented contacts per user in an address book and making determinations as to which device may be the best option for reaching a particular user at a particular time. Multiple user identities and multiple device associations can potentially be combined with service provider network based filtering and call forwarding applications to provide simple easy to use applications that give the user powerful control over the manner in which their incoming and outgoing communications are handled.

The teachings of the present disclosure are relevant within a wide variety of contexts. Systems based upon SIP are capable of providing the user with the ability to explicitly register multiple SIP URIs with a SIP core network using the SIP Registration mechanism specified in RFC 3261 and/or provided to the device through network provisioning notification using the P-Associated-URI header defined in RFC 3455. Mechanisms such as HTTP (GET and PUT etc), XCAP (RFC 4825), SIP based Event mechanisms such as SIP PUBLISH (RFC 3903) and SUBSCRIBE/NOTIFY (RFC 3265) amongst others, can be used to provide communication of such application level data between the device and the application server.

In certain embodiments, information about user identities, device identities and their relationships may be “piggy-backed” onto existing communication mechanisms between devices and the application server. Since most devices and applications will support some initial device to application server communication shortly after the device is powered on or the relevant application is started, use of this mechanism may require minimal, if any, additional load on the network. In general, the present disclosure is directed to systems and networks within which a device and/or user identity may be authenticated by a trusted server or network, but an application server elsewhere within the network may not be operable to fully and reliably authenticate the identity of the device and/or a user identity itself. Thus, the present disclosure provides an apparatus and method by which such an application server can improve the likelihood that a device asserting authority on behalf of a particular user identifier is, in fact, authorized to assert such authority. In order to improve security, certain embodiments of the present disclosure make use of authenticated and private communication between the devices and the application server. Such security can be provided, for example, by means of encryption. Those of skill in the art will appreciate that a number of security enhancement mechanisms could be employed in connection with the foregoing systems, including but not limited to CHAP and HMAC.

The present disclosure provides for the use of one or more authentication keys which are used to authenticate user and device combinations. The authentication key(s) may be generated the first time a device or application establishes an interaction with an application server and provided to the application server at that time. Subsequent initial interactions with the application server for a different alias URI for the same user and/or device may be authenticated so long as a previously-authenticated alias URI is still valid.

The new alias URI is authenticated by reference to a valid alias URI (Assoc-id) and will include the associated key (Assoc-Key) that was previously provided in the initial communication using the previous alias URI. Thus, multiple alias URIs can be communicated by the same device to the application server, which can verify by the shared associated key that they are indeed true alias URIs of the same user and same device and not impostors. A popular representation of synchronization and other application data in this kind of device to application server communications is XML (Extensible Markup Language). XML is used in the specific examples set forth below but other data representation formats are envisioned and possible.

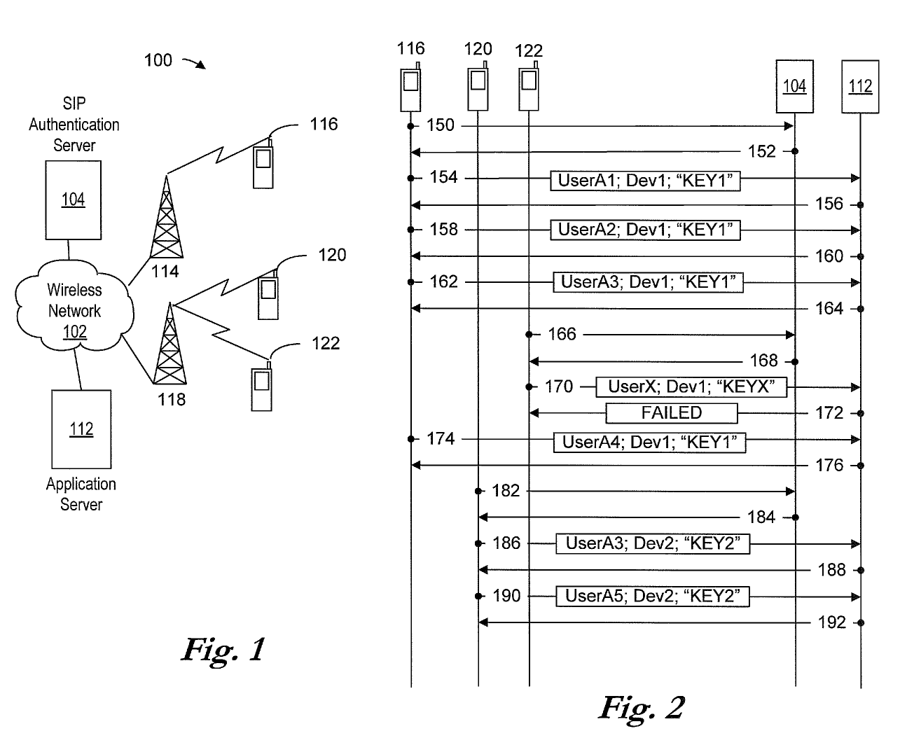

Referring now to the drawings, and more particularly to FIG. 1, depicted therein is an exemplary network environment 100 including a wireless packet data service network 102 wherein certain embodiments of the present system may be practiced. An authentication server 104 is operably connected to wireless packet data service network 102. Wireless packet data service network 102 is also operably connected to an application server 112 and to base stations 114 and 118. Those of skill in the art will appreciate that a diverse array of devices, including but not limited to additional servers, desktop computers, laptop computers, palmtop computers, et cetera, although not specifically shown in FIG. 1, may be operably connected to the wireless network 102, either directly or indirectly.

Application server 112 may, in certain implementations, enable a corporate user to access or effectuate any of the services from a remote location using suitable equipment such as mobile communications devices 116, 120, 122. By way of example, mobile communications device 116 may be a data-enabled wireless handheld device capable of receiving and sending messages, web browsing, interfacing with corporate application servers, et cetera. A secure communication link with end-to-end encryption may be established that is mediated through an external IP network, i.e., a public packet-switched network such as the Internet, as well as the wireless packet data service network 102 operable with mobile communications device 116 via suitable wireless network infrastructure that includes a base station (BS) 114.

For purposes of the present disclosure, the wireless packet data service network 102 may be implemented in any known or heretofore unknown mobile communications technologies and network protocols. For instance, the wireless packet data service network 102 may be comprised of a General Packet Radio Service (GPRS) network that provides a packet radio access for mobile devices using the cellular infrastructure of a Global System for Mobile Communications (GSM)-based carrier network. In other implementations, the wireless packet data service network 102 may comprise an Enhanced Data Rates for GSM Evolution (EDGE) network, an Integrated Digital Enhanced Network (IDEN), a Code Division Multiple Access (CDMA) network, Universal Mobile Telecommunications System Terrestrial Radio Access Network (UTRAN), Evolved UTRAN (E-UTRAN), 802.1x WLAN, or any 3rd Generation (3G) network.

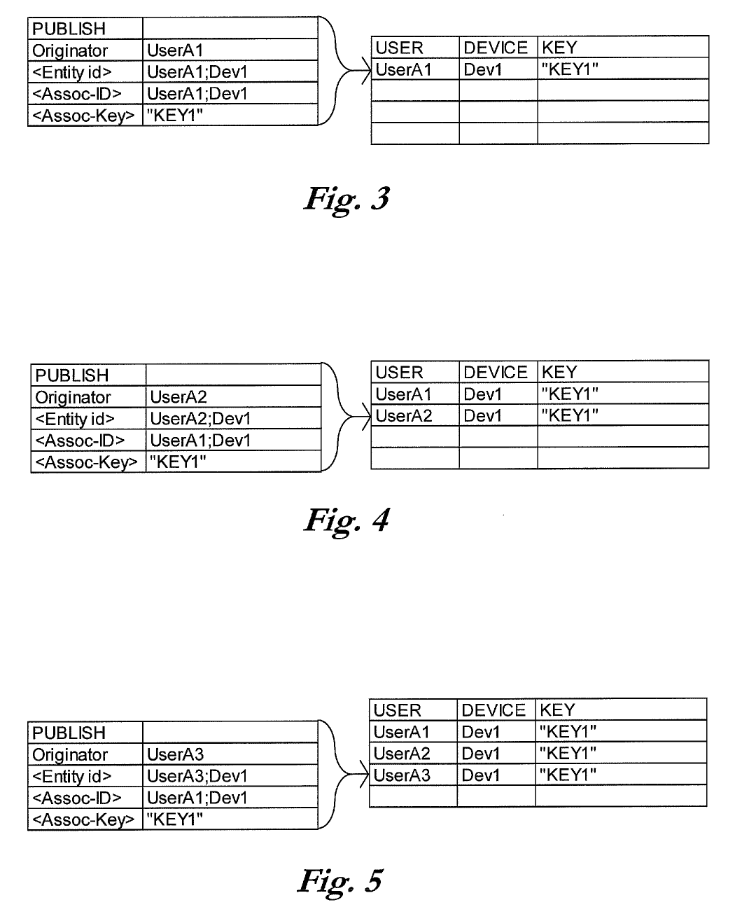

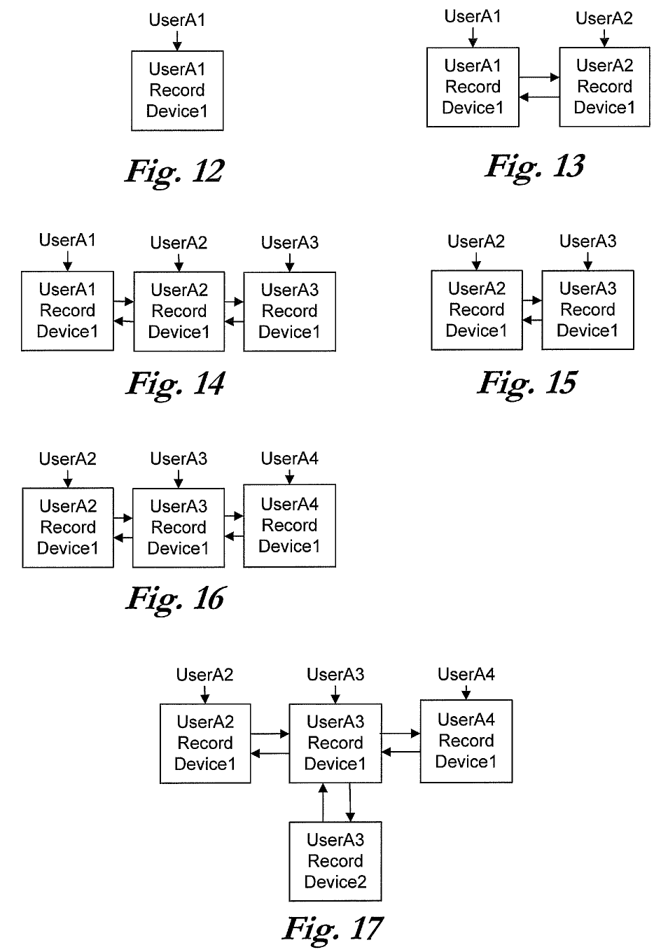

FIG. 2 depicts a message flow between mobile communications devices 116, 120, 122 and servers 104, 112 according to certain implementations. Message 150 represents an initial request for service from mobile communication device 116 to authentication server 104. Message 152 represents the response from authentication server 104 to mobile communication device 116. It will be understood and appreciated by those of skill in the art that the authentication systems and methods described herein are operable to help reduce potential security issues that may be presented by the use of alias relationships between devices and user identifiers. It will also be understood and acknowledged by those of skill in the art that the systems and methods described herein are not necessarily operable to correct security weaknesses found elsewhere in the network. Thus, while the systems and methods of the present invention are operable to help ensure that a second entity asserting an alias relationship with a first entity does in fact have such authority, the present methods and systems do not provide mechanisms for independent authentication of the authority of the first identity. Authentication of the first entity will be provided, if at all, by other portions of the network, including but not necessarily limited to authentication server 104. Once mobile communication device 116 is registered and authenticated to authentication server 104, mobile communication device 116 can communicate with application server 112. In message 154, mobile communication device 116 sends a communication to application server 112 comprising a user ID (UserA1), a device ID (Dev1) and an authentication key (“KEY1”). This message is stored in an authentication database within application server 112. This transaction and the subsequent database status are shown in further detail in FIG. 3. The status of the data structure after this transaction is depicted in FIG. 12. Subsequent to the transaction, Application server 112 acknowledges message 154 by means of message 156.

Although the above transaction can be effectuated within a wide variety of contexts, and for a variety of purposes, the transaction is described below within the context of Push-to-talk over Cellular (PoC) functionality in the SIP protocol as an illustrative example. Within this context, a first PoC Client registers PoC-UserA1@networkA.net with the SIP/IP Core and Publishes, using SIP PUBLISH method, the PoC Service Settings for PoC-UserA1@networkA.net. The PoC Service Settings document has an already defined <entity> element with an “id” attribute.

The intent of the “id” attribute is to uniquely identify the entity to which these particular settings belong. In this case, mobile communication device 116 includes the concatenation of PoC-UserA1@networkA.net with the unique identity of the device using the URN format of the sip.instance feature tag defined in draft-ietf-sip-outbound. This uniquely identifies that these settings are for the user identity PoC-UserA1@networkA.net on the device with the sip.instance identity urn:uuid:f81d4fae-7dec-11d0-a765-00a0c91e6b. Mobile communication device 116 also includes the new XML element <ref-id-key> containing the sub elements <assoc-id> and <assoc-key>. Since this is the first URI to be communicated to the PoC Server, mobile communication device 116 sets the “id” attribute of the <Assoc-id> element to the same as the “id” attribute of the <entity> element (POC-UserA1@networkA.net>;+sip.instance=<urn:uuid:f81d4fae-7dec-11d0-a765-00a0c91e6b) and generates the random key a5so6iw78py68use2wdvb and includes it in the “key” attribute of the <assoc-key> element. Example XML for this transaction may have the following form:

<?xml version=“1.0” encoding=“UTF-8”?>
<poc-settings xmlns=“urn:oma:params:xml:ns:poc:poc-

settings”>

| | |
|---|---|
| <entity | id=“PoC- |

UserA1@networkA.net;+sip.instance=<urn:uuid:f81d4fae-
7dec-11d0-a765-00a0c91e6b>”>

<ref-id-key>

| | |
|---|---|
| <assoc-id | id=“PoC- |

UserA@networkA1.net;+sip.instance=<urn:uuid:f81d4fae-
7dec-11d0-a765-00a0c91e6b>”/>

<assoc-key key=“a5so6iw78py68use2wdvb”/>

</ref-id-key>
<isb-settings>

<incoming-session-barring active=“true”/>

</isb-settings>
<am-settings>

<answer-mode>automatic</answer-mode>

</am-settings>
<ipab-settings>

<incoming-personal-alert-barring

active=“false”/>

</ipab-settings>
<sss-settings>

<simultaneous-sessions-support

active=“true”/>

</sss-settings>

</entity>

</poc-settings>

Once an authentication key has been generated and communicated to application server 112, mobile communication device 116 can use the registered authentication key to authenticate other identifiers to application server 112. In message 158, mobile communication device 116 sends a communication to application server 112 comprising a second user ID (UserA2), a device ID (Dev1) and the authentication key (“KEY1”). This communication is shown in further detail in FIG. 4. It can be seen in FIG. 4 that the communication also includes an associated user ID and associated device ID (UserA1; Dev1). Since <Entity id> and <Assoc ID> are not the same, the application server 112 determines that UserA2 is asserting that UserA2 is associated with UserA1, and since the Assoc-Key matches the stored key for UserA1, application server 112 determines that UserA2 is associated with UserA1 registered on mobile communication device 116, and the new user data is stored at application server 112. The status of the data structure after this transaction is depicted in FIG. 13. Subsequent to the transaction, application server 112 acknowledges message 158 by means of message 160.

Within the PoC context presented as an illustrative example, mobile communication device 116 registers PoC-UserA2@networkA.net with the SIP/IP Core and Publishes using SIP PUBLISH method the PoC Service Settings for PoC-UserA2@networkA.net. In this case, mobile communication device 116 includes the concatenation of PoC-UserA2@networkA.net with the unique identity of the device using the sip.instance feature tag which uniquely identifies that these settings are for the user identity PoC-UserA2@networkA.net on the device with the sip.instance identity urn:uuid:f81d4fae-7dec-11d0-a765-00a0c91e6b. Since the URI PoC-UserA1@networkA.net is still valid for the PoC Service and is an alias of PoC-UserA2@networkA.net, mobile communication device 116 sets the “id” attribute of the <Assoc-id> element to PoC-UserA1@networkA.net>;+sip.instance=<urn:uuid:f81d4fae-7dec-11d0-a765-00a0c91e6b) and includes the previously used random key a5so6iw78py68use2wdvb in the “key” attribute of the <assoc-key> element. Example XML for this transaction may have the following form:

<?xml version=“1.0” encoding=“UTF-8”?>
<poc-settings xmlns=“urn:oma:params:xml:ns:poc:poc-

settings”>

| | |
|---|---|
| <entity | id=“PoC- |

UserA2@networkA.net;+sip.instance=<urn:uuid:f81d4fae-
7dec-11d0-a765-00a0c91e6b>”>

<ref-id-key>

| | |
|---|---|
| <assoc-id | id=“PoC- |

UserA@networkA1.net;+sip.instance=<urn:uuid:f81d4fae-
7dec-11d0-a765-00a0c91e6b>”/>

<assoc-key key=“a5so6iw78py68use2wdvb”/>

</ref-id-key>
<isb-settings>

<incoming-session-barring active=“true”/>

</isb-settings>
<am-settings>

<answer-mode>automatic</answer-mode>

</am-settings>
<ipab-settings>

<incoming-personal-alert-barring

active=“false”/>

</ipab-settings>
<sss-settings>

<simultaneous-sessions-support

active=“true”/>

</sss-settings>

</entity>

</poc-settings>

In message 162, mobile communication device 116 sends a communication to application server 112 comprising a third user ID (UserA3), the first device ID (Dev1) and the original authentication key (“KEY1”). This communication is shown in further detail in FIG. 5. It can be seen in FIG. 5 that the communication also includes an associated user ID and associated device ID (UserA1; Dev1). Since the transmitted authentication key matches the stored authentication key associated with the referenced user ID and device ID, the new user data is stored at application server 112. The status of the data structure after this transaction is depicted in FIG. 14. Subsequent to the transaction, application server 112 acknowledges message 162 by means of message 164.

Within the PoC context described above, mobile communication device 116 registers PoC-UserA3@networkA.net with the SIP/IP Core and Publishes using SIP PUBLISH method the PoC Service Settings for PoC-UserA3@networkA.net. In this case, mobile communication device 116 includes the concatenation of PoC-UserA3@networkA.net with the unique identity of the device using the sip.instance feature tag, which uniquely identifies that these settings are for the user identity PoC-UserA3@networkA.net on the device with the sip.instance identity urn:uuid:f81d4fae-7dec-11d0-a765-00a0c91e6b. Since the URI PoC-UserA1@networkA.net is still valid for the PoC Service and is an alias of PoC-UserA3@networkA.net, mobile communication device 116 sets the “id” attribute of the <Assoc-id> element to PoC-UserA1@networkA.net>;+sip.instance=<urn:uuid:f81d4fae-7dec-11d0-a765-00a0c91e6b) and includes the previously used random key a5so6iw78py68use2wdvb in the “key” attribute of the <assoc-key> element. Example XML for this transaction may have the following form:

<?xml version=“1.0” encoding=“UTF-8”?>
<poc-settings xmlns=“urn:oma:params:xml:ns:poc:poc-

settings”>

| | |
|---|---|
| <entity | id=“PoC- |

UserA3@networkA.net;+sip.instance=<urn:uuid:f81d4fae-
7dec-11d0-a765-00a0c91e6b>”>

<ref-id-key>

| | |
|---|---|
| <assoc-id | id=“PoC- |

UserA@networkA1.net;+sip.instance=<urn:uuid:f81d4fae-
7dec-11d0-a765-00a0c91e6b>”/>

<assoc-key key=“a5so6iw78py68use2wdvb”/>

</ref-id-key>
<isb-settings>

<incoming-session-barring active=“true”/>

</isb-settings>
<am-settings>

<answer-mode>automatic</answer-mode>

</am-settings>
<ipab-settings>

<incoming-personal-alert-barring

active=“false”/>

</ipab-settings>
<sss-settings>

<simultaneous-sessions-support

active=“true”/>

</sss-settings>

</entity>

</poc-settings>

In one embodiment, a subsequent registration may be able to refer to the first identity which created the group, or any identity associated with the group already. However if the URI PoC-UserA1@enetworkA.net was no longer still valid for the PoC Service but PoC-UserA2@networkA.net was still valid for the PoC Service and was an alias of PoC-UserA3@networkA.net, mobile communication device 116 would then set the “id” attribute of the <Assoc-id> element to PoC-UserA2@networkA.net>;+sip.instance=<urn:uuid:f81d4fae-7dec-11d0-a765-00a0c91e6b) and include the previously used random key a5so6iw78py68use2wdvb in the “key” attribute of the <assoc-key> element. Thus, so long as there is still a valid alias address communicated to the PoC Server, the mechanism still functions, even if the first URI communicated is no longer valid.

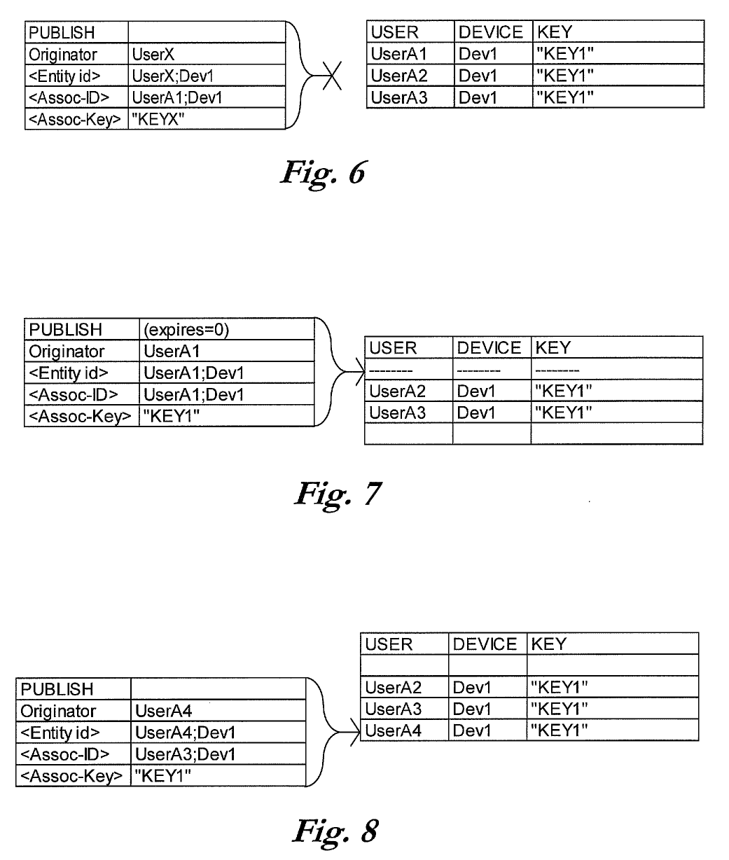

The authentication keys stored at application server 112 enable valid devices to set up new aliases efficiently and also serve to prevent unauthorized devices from setting up unauthorized aliases. The latter functionality is shown in detail in connection with messages 166-172. Message 166 represents an initial request for service from mobile communication device 122 to authentication server 104. Message 168 represents the response from authentication server 104 to mobile communication device 122. Once mobile communication device 122 is registered and authenticated to authentication server 104, mobile communication device 122 can communicate with application server 112. Message 170 represents an attempt by mobile communication device 122 to create a new user “UserX” as an alias of UserA1. This communication is shown in further detail in FIG. 6. When application server 112 checks the authentication key transmitted by mobile communication device 122, application server 112 determines that the authentication key provided (“KeyX”) does not match any authentication key stored at application server 112 in association with UserA1 and Dev1. Accordingly, application server 112 refuses to create the new alias, and may return a message, such as message 172 indicating that authentication has failed.

In certain applications, a previously-created user ID may expire, be de-registered or otherwise become invalid either because of the occurrence of a particular event or sequence of events, the expiration of a predetermined time period, or an express instruction to cancel, delete or de-register the ID. An example of such a situation is shown in detail in FIG. 7, wherein the record for UserA1 is de-registered pursuant to an express instruction. The status of the data structure after this transaction is depicted in FIG. 15. It can be seen that the expiration of UserA1 does not necessarily result in the expiration, de-registration or invalidation of associated user identifiers UserA2 and UserA3, although it may in certain implementations.

Returning to FIG. 2, message 174 represents a communication from mobile communication device 116 to application server 112 comprising a fourth user ID (UserA4), a device ID (Dev1) and the original authentication key (“KEY1”). This communication is shown in further detail in FIG. 8. It can be seen in FIG. 8 that the communication also includes an associated user ID and associated device ID (UserA3; Dev1). The new alias is associated with active user ID “UserA3” rather than the expired initial user ID “UserA1.” Since the transmitted authentication key matches the stored authentication key associated with the referenced user ID and device ID, the new user data is stored at application server 112. The status of the data structure after this transaction is depicted in FIG. 16. Subsequent to the transaction, application server 112 acknowledges message 162 by means of message 164.

Message 182 represents an initial request for service from mobile communication device 120 to authentication server 104. Message 184 represents the response from authentication server 104 to mobile communication device 120. Once mobile communication device 120 is registered and authenticated to authentication server 104, mobile communication device 120 can communicate with application server 112. As noted above, the authentication systems and methods described herein are operable to help reduce potential security issues that may be presented by the use of alias relationships between devices and user identifiers, but are not necessarily operable to correct security weaknesses found elsewhere in the network. Thus, the present methods and systems do not necessarily provide mechanisms for independent authentication of the authority or identity of any particular entity, except in relation to that entity's authority to act on behalf of another entity. Thus, the teachings of the present disclosure will generally be implemented in connection with additional security and authentication measures.

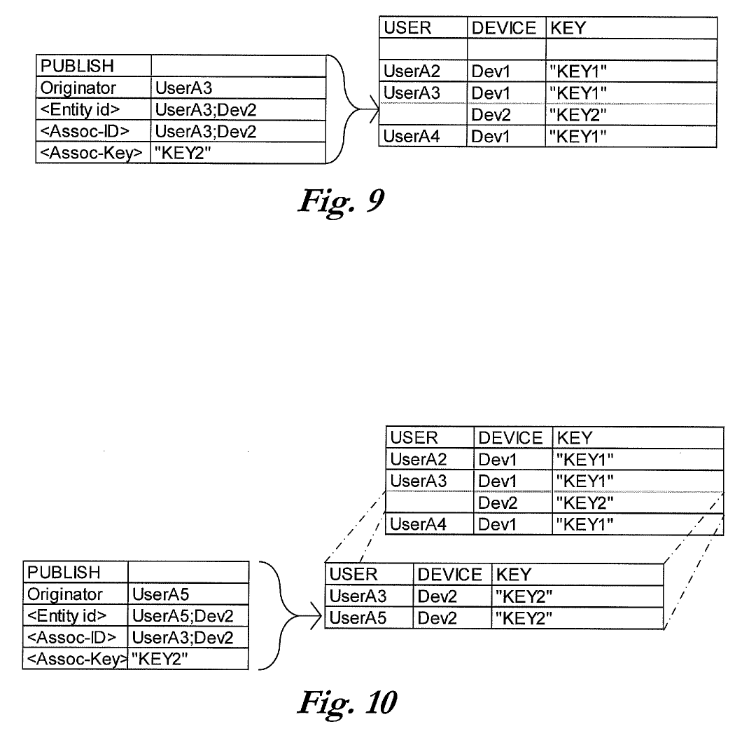

In message 186, mobile communication device 120 sends a communication to application server 112 comprising a user ID (UserA3), a device ID (Dev2) and an authentication key (“KEY2”). This communication is shown in further detail in FIG. 9. Since <Entity id> and <Assoc-ID> are the same but the <Entity id> contains a device identity different from the device identity currently associated with UserA3, application server 112 determines that a second device (Dev2) is being registered for UserA3 and associates this device with the new authentication key. This information is stored within application server 112. The status of the data structure after this transaction is depicted in FIG. 17. Subsequent to this transaction, application server 112 acknowledges message 186 by means of message 188.

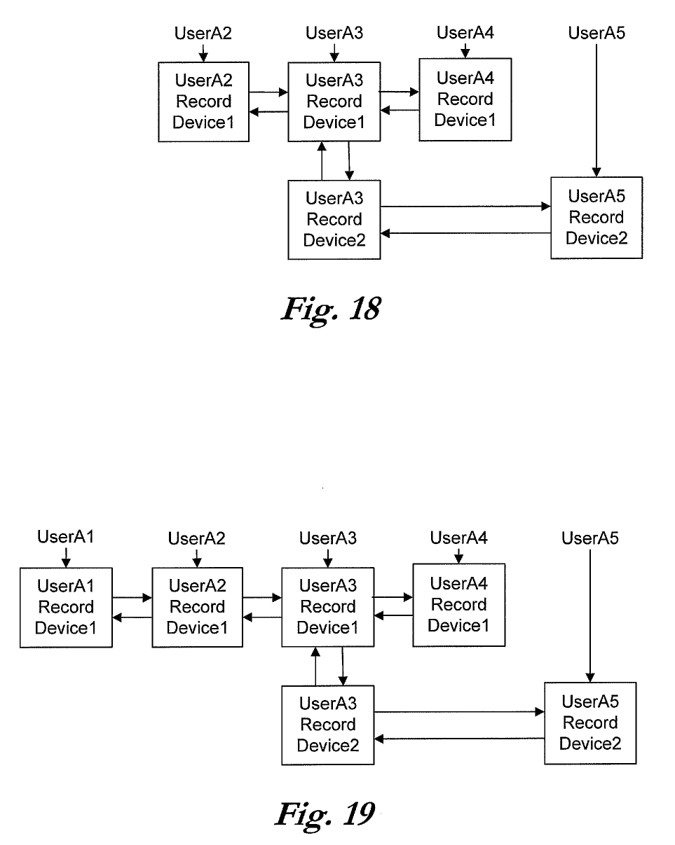

Message 190 represents a communication from mobile communication device 120 to application server 112 comprising a fifth user ID (UserA5), a device ID (Dev2) and the original authentication key (“KEY2”). This communication is shown in further detail in FIG. 10. It can be seen in FIG. 10 that the communication also includes an associated user ID and associated device ID (UserA3; Dev2). Since the transmitted authentication key matches the stored authentication key associated with the referenced user ID and device ID, the new user data is stored at application server 112, as shown in FIG. 10. The status of the data structure after this transaction is depicted in FIG. 18. Subsequent to this transaction, application server 112 acknowledges message 190 by means of message 192.

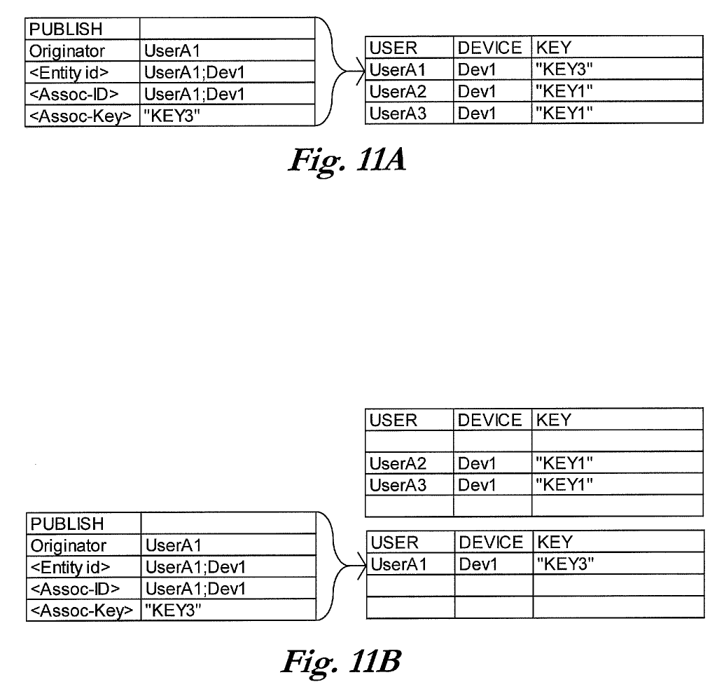

Subsequent in time to the expiration of UserA1 as set forth above, mobile communication device 116 may re-register UserA1 in a similar manner to that set forth above in connection with messages 154 and 156. This may occur periodically, or may be initiated by circumstances such as a power off or loss of radio coverage. Under such circumstances, registration of one or more of the user identities with the application server 112 may be effectuated using a new authentication key generated at mobile communication device 116. This transaction is shown in tabular form in FIGS. 11A and 11B, wherein UserA1 is reregistered with application server 112 and associated with authentication key “KEY3”. FIG. 11A depicts an embodiment wherein re-registration of UserA1 with a new authentication key re-inserts UserA1 back into the same data set into which it was inserted originally. After this transaction, the data structure may have a form similar to that shown graphically in FIG. 14. In certain embodiments, application server 112 may automatically update the records, if any, for associated user identifiers to incorporate the new authentication key. In other embodiments, application server 112 may automatically delete the records, if any, associated with a prior authentication key. In other embodiments, each individual record may need to be updated discretely. Those of skill in the art will appreciate that other approaches are possible. In an alternate embodiment, shown in FIG. 11B, registration of UserA1 in connection with a new key may result in creation of a new, parallel table incorporating a separate set of associated user identifier aliases, which may be aliases of one another but not necessarily aliases of any of the user identifiers in the original data set. In certain embodiments, a new XML element may be defined to carry the necessary parameters for re-registration. In other embodiments, an existing XML Element containing an existing identity element may be used to encode the parameters. In yet another embodiment, a SIP header or HTTP header may be used to encode the parameters. Other embodiments for encoding the parameters are possible depending on the protocol used for transport or the encoding schema used for the data.

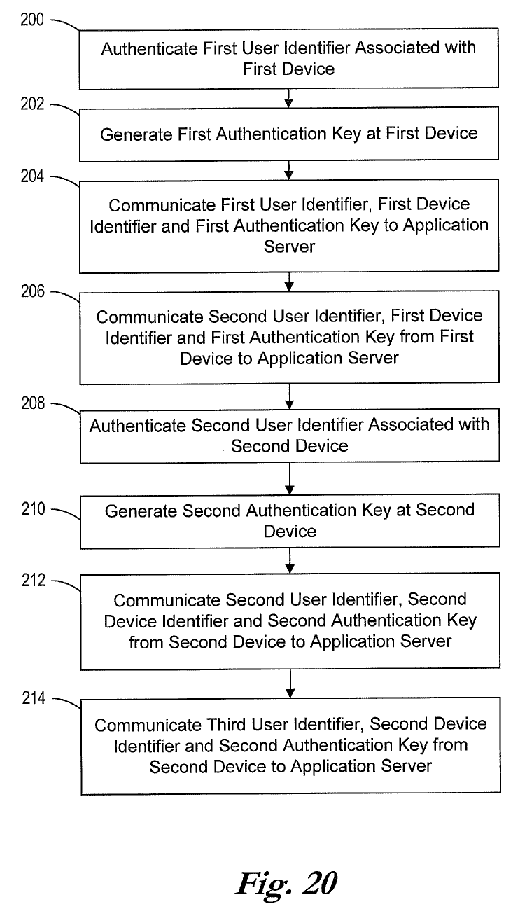

FIG. 20 depicts a flow chart showing a first process for asserting an alias of a user identity and associating the alias with two devices. In block 200, a first user identifier associated with a first device is authenticated to a network via an authentication server. In block 202, a first authentication key is generated at the first device. In block 204, the first authentication key is communicated from the first device to an application server in connection with a first user identifier and a first device identifier. In block 206, the first authentication key is communicated from the first device to the application server in connection with the second user identifier and the first device identifier. In block 208, the second user identifier is authenticated to the network in connection with a second device via an authentication server. In block 210, a second authentication key is generated at the second device. In block 212, the second authentication key is communicated from the second device to the application server in connection with the second user identifier and a second device identifier. In block 214, the second authentication key is communicated from the second device to the application server in connection with a third user identifier and the second device identifier.

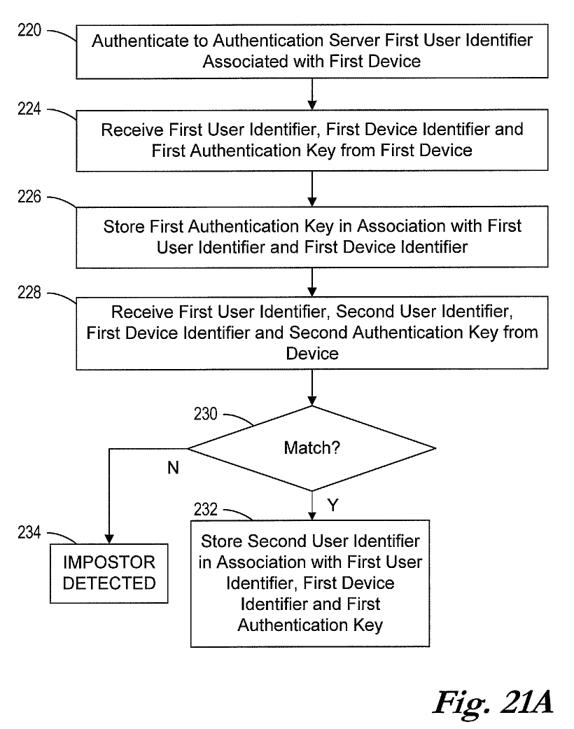

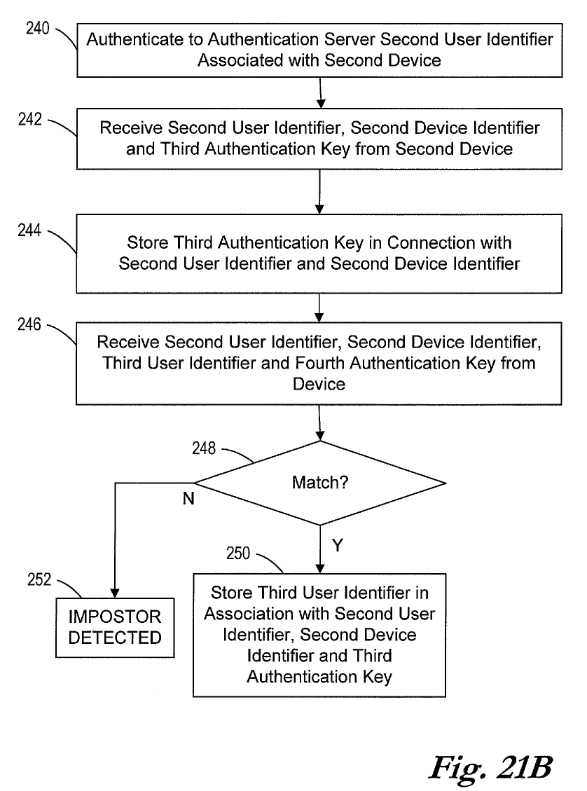

FIG. 21A depicts a flow chart showing a second process for asserting an alias of a user identity. In block 220, a first user identifier, associated with a first device, is authenticated to a network via one or more authentication servers. In block 224, a first authentication key, first user identifier and a first device identifier are received from the first device. Those of skill in the art will appreciate that more information or less information may be appropriate, depending on a particular application. In block 226, the first authentication key is stored in association with the first user identifier and the first device identifier. In block 228, the first user identifier, the second user identifier, the first device identifier and a second authentication key are received from a device, which may be the first device. As above, those of skill in the art will appreciate that more information or less information may be appropriate in a particular application. Process flow from decision block 230 depends upon whether there is a match between the second authentication key received from the device along with the first user identifier and first device identifier and the first authentication key stored at the application server in connection with those identifiers. If there is a match, process flow proceeds to block 232. If there is not a match, process flow proceeds to block 234.

In block 232, an authentication key and identifier match has been found, and the second user identifier is therefore stored as an alias in association with the first user identifier and the first device identifier. Subsequently, the server will treat the second user identifier as an alias of the first user identifier. Alternately, in block 234, the server has determined that the user and/or device claiming to act on authority of the first user identifier does not, in fact, have such authority, thus indicating that the entity claiming to act on behalf of the first user identifier is an impostor. Thus, the server will not store a new alias record or treat the second user identifier as an alias of the first user identifier.

FIG. 21B depicts a flow chart showing a third process for asserting an alias of a user identity. In block 240, a second user identifier, associated with a second device, is authenticated to an authentication server. In block 242, a second user identifier, a second device identifier and a third authentication key is received from the second device. In block 244, the third authentication key is stored in connection with the second user identifier and the second device identifier. In block 246, the second user identifier, a third user identifier, the second device identifier and a fourth authentication key are received from a device, which may be the second device. Process flow from decision block 248 depends on whether there is a match between the fourth authentication key provided by the device in connection with the second user identifier and second device identifier and the third authentication key stored at the application server in connection with those identifiers. If there is a match, process flow proceeds to block 250. If there is not a match, process flow proceeds to block 252. In block 250, a match has been found and the third user identifier is stored at the application server in association with the second user identifier, the second device identifier and the third authentication key. Alternately, in block 252, an impostor is detected and the process ends. As mentioned above, any of the above communications may include more information or less information, depending on the particulars of a specific application.

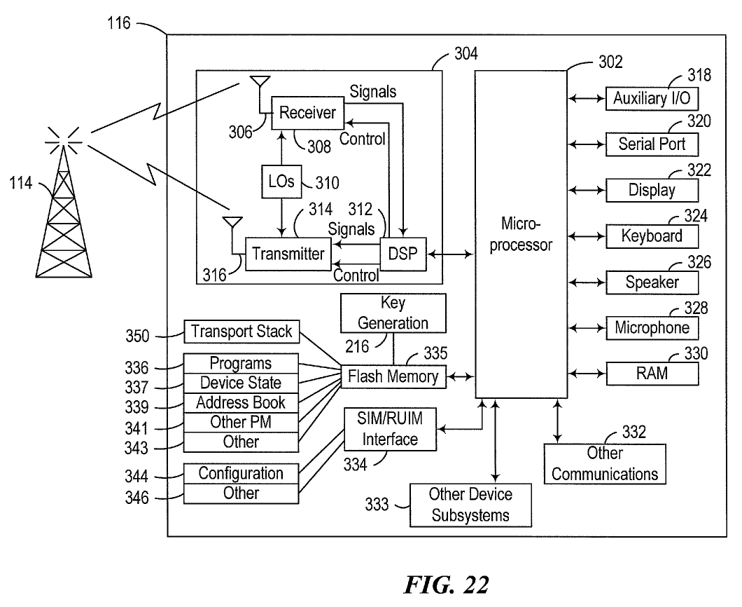

FIG. 22 depicts a block diagram of a mobile communications device according to one embodiment. It will be recognized by those skilled in the art upon reference hereto that although an embodiment of mobile communication device 116 may comprise an arrangement similar to one shown in FIG. 22, there can be a number of variations and modifications, in hardware, software or firmware, with respect to the various modules depicted. Accordingly, the arrangement of FIG. 22 should be taken as illustrative rather than limiting with respect to the embodiments of the present disclosure.

A microprocessor 302 providing for the overall control of an embodiment of mobile communication device 116 is operably coupled to a communication subsystem 304 which includes a receiver 308 and transmitter 314 as well as associated components such as one or more local oscillator (LO) modules 310 and a processing module such as a digital signal processor 312. As will be apparent to those skilled in the field of communications, the particular design of the communication module 304 may be dependent upon the communications network with which the mobile communication device 116 is intended to operate.

In one embodiment, the communication module 304 is operable with both voice and data communications. Regardless of the particular design, however, signals received by antenna 306 through base station 114 are provided to receiver 308, which may perform such common receiver functions as signal amplification, frequency down conversion, filtering, channel selection, analog-to-digital (A/D) conversion, and the like. Similarly, signals to be transmitted are processed, including modulation and encoding, for example, by digital signal processor 312, and provided to transmitter 314 for digital-to-analog (D/A) conversion, frequency up conversion, filtering, amplification and transmission over the air-radio interface via antenna 316.

Microprocessor 302 also interfaces with further device subsystems such as auxiliary input/output (I/O) 318, serial port 320, display 322, keyboard 324, speaker 326, microphone 328, random access memory (RAM) 330, a short-range communications subsystem 332, and any other device subsystems generally labeled as reference numeral 333. To control access, a Subscriber Identity Module (SIM) or Removable User Identity Module (RUIM) interface 334 is also provided in communication with the microprocessor 302. Access control methods may vary between different RATs (e.g., between Wi-fi and WiMAX).

In one implementation, SIM/RUIM interface 334 is operable with a SIM/RUIM card having a number of key configurations 344 and other information 346 such as identification and subscriber-related data. Operating system software and transport stack software may be embodied in a persistent storage module (i.e., non-volatile storage) such as Flash memory 335. In one implementation, flash memory 335 may be segregated into different areas, e.g., a storage area for computer programs 336 as well as data storage regions such as device state 337, address book 339, other personal information manager (PIM) data 341, and other data storage areas generally labeled as reference numeral 343. A key generation module 216 is operably connected to flash memory 335, which also includes transport stack 350.

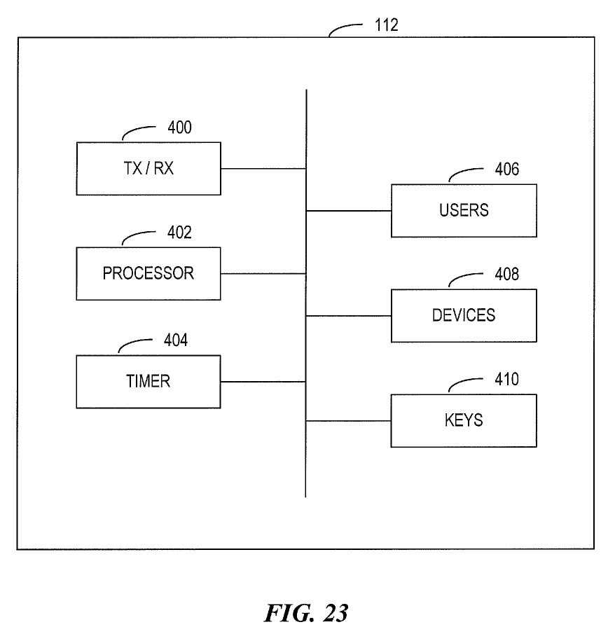

FIG. 23 depicts a block diagram of a application server 112 according to certain aspects of the present disclosure. Application server 112 comprises a TX/RX module 400, a processor 402 and a timer 404. Application server 112 further includes storage locations for data, including a users database 406, a devices database 408 and a keys database 410. Those of skill in the art will appreciate that the elements shown in FIG. 23 are presented solely by way of example. Particular embodiments may incorporate more or fewer elements as required by a particular application.

It is believed that the operation and construction of the embodiments of the present disclosure will be apparent from the Detailed Description set forth above. While the exemplary embodiments shown and described may have been characterized as being preferred, it should be readily understood that various changes and modifications could be made therein without departing from the scope of the present disclosure as set forth in the following claims.

What is claimed is:

1. A method for secure assertion of a user identifier alias comprising:
receiving at an application server from a first device a first user identifier, a first device identifier and a first authentication key associated with the first device;
receiving at the application server from the first device a second user identifier, the first device identifier and a second authentication key associated with the first device;
comparing the first authentication key to the second authentication key; and
storing the second user identifier at the application server as an alias of the first user identifier if the first authentication key matches the second authentication key.

2. The method as recited in claim 1, wherein the first device and the application server communicate via a wireless data path.

3. The method as recited in claim 1, wherein the first device and the application server communicate via a wireless packet service data path.

4. The method as recited in claim 1, wherein the first device and the application server communicate via a wide area cellular network.

5. The method as recited in claim 1, further comprising:
receiving at the application server, from a second device, the second user identifier, a second device identifier and a third authentication key; and
storing the second device identifier at the application server as an associated device for the second user identifier.

6. The method as recited in claim 5, further comprising:
receiving at the application server from the second device a third user identifier, the second device identifier and the third authentication key; and
storing the third user identifier at the application server as an alias of the second user identifier.

7. The method as recited in claim 6, further comprising transmitting to the second device a communication directed to the third user identifier.

8. A method for secure assertion of a user identifier alias comprising:
sending to an application server from a first device a first user identifier, a first device identifier and a first authentication key associated with the first device;
sending to the application server from the first device a second user identifier, the first device identifier and the first authentication key; and
receiving at the first device a communication directed to the second user identifier as a result of an alias relationship at the application server between the first user identifier and the second user identifier.

9. The method as recited in claim 8, wherein the first device and the application server communicate via a wireless data path.

10. The method as recited in claim 8, wherein the first device and the application server communicate via a wireless packet service data path.

11. The method as recited in claim 8, wherein the first device and the application server communicate via a wide area cellular network.

12. The method as recited in claim 8, further comprising:
sending to the application server, from a second device, the second user identifier, a second device identifier and a third authentication key.

13. The method as recited in claim 8, further comprising sending from the first device a communication associated with the first user identifier.

14. The method as recited in claim 8, further comprising sending from the first device a communication associated with the second user identifier.

15. An application server comprising:
means for receiving at the application server from a first device a first user identifier, a first device identifier and a first authentication key associated with the first device;
means for receiving at the application server from the first device a second user identifier, the first device identifier and a second authentication key associated with the first device;
means for comparing the first authentication key to the second authentication key; and
means for storing the second user identifier at the application server as an alias of the first user identifier if the first authentication key matches the second authentication key.

16. The server as recited in claim 15, wherein the first device and the application server communicate via a wireless data path.

17. The server as recited in claim 15, wherein the first device and the application server communicate via a wireless packet service data path.

18. The server as recited in claim 15, wherein the first device and the application server communicate via a wide area cellular network.

19. The server as recited in claim 15, further comprising:
means for receiving at the application server, from a second device, the second user identifier, a second device identifier and a third authentication key; and
means for storing the second device identifier at the server as an associated device for the second user identifier.

20. The application server as recited in claim 19, further comprising:
means for receiving at the application server from the second device a third user identifier, the second device identifier and the third authentication key; and
means for storing the third user identifier as an alias for the second user identifier.

21. A mobile communication device comprising:
means for sending to an application server from the mobile communication device a first user identifier, a first device identifier and a first authentication key associated with the first device;
means for sending to the application server from the mobile communication device a second user identifier, the first device identifier and the first authentication key; and
means for receiving at the mobile communication device a communication directed to the second user identifier as a result of an alias relationship at the application server between the first user identifier and the second user identifier.
